(19) United States
(12) Patent Application Publication
(10) Pub. No.: US 2021/0095503 A1
(43) Pub. Date: Apr. 1, 2021

(54) Folding System

(71) Applicant: Solarlux GmbH, Melle (DE)

(72) Inventor: Björn Nussbaum, Osnabrück (DE)

(21) Appl. No.: 17/031,954

(22) Filed: Sep. 25, 2020

(30) Foreign Application Priority Data
Sep. 26, 2019 (DE) 10 2019 125 988.6

(51) Int. Cl. E05C 9/04; E06B 3/92; E06B 3/48; E05C 9/22

(52) U.S. Cl. CPC E05C 9/04; E05C 9/22; E06B 3/481; E06B 3/924

(57) ABSTRACT

A folding system has a bottom guide rail and a top guide rail. A first folding wing and a second folding wing are supported movably in the bottom guide rail and the top guide rail, respectively. The first folding wing has a vertically extending frame section. A lock fitting is arranged in the vertically extending frame section of the first folding wing and has a vertically slidably supported locking pin. A locking gear is connected to the locking pin and can move the locking pin into and out of one of the bottom and top guide rails. A reinforcement pin is arranged parallel to the locking pin in the vertically extending frame section of the first folding wing. The locking pin and the reinforcement pin are connected to each other such that the reinforcement pin is entrained parallel to the locking pin when the locking gear is actuated.

### BACKGROUND OF THE INVENTION

The invention relates to a folding system, especially a glazed folding system, with at least two folding wings that are movably guided in a guide comprising guide rails at the top and at the bottom. At least one folding wing comprises a frame section that extends vertically and accommodates a lock fitting with at least one locking pin that is supported so as to be vertically slidable and is arranged to be moved into and out of the guide rail at the top and/or at the bottom by means of a locking gear.

For opening the folding wings of the folding system, the folding wings can be moved in the guide rails and/or can be pivoted out of the guide rails. In the closed position, a locking action is required. For this purpose, a lock fitting is accommodated in the frame section of at least one of the folding wings. By means of a locking gear, locking pins can be moved at least at the top and at the bottom into the guide rail or moved out of the guide rail when the folding system is to be opened again.

In order to provide an improved securing action, in U.S. Pat. No. 8,109,315 a locking mechanism is already proposed in which the neighboring frame section of the folding wing adjoining the folding wing to be locked also comprises a lock bar that is simultaneously actuatable by means of followers at the lock fitting. This construction provides for an increased protection against burglary but is relatively complex.

The invention has therefore the object to provide a folding system with a safe locking action that is of a simple construction and is robust.

### SUMMARY OF THE INVENTION

This object is solved by a folding system in which the locking pin is connected to a reinforcement pin which is arranged parallel to the locking pin in the frame section of the same folding wing and which is entrained parallel to the locking pin by means of the locking gear.

By providing at least one locking pin functioning as a reinforcement pin in the frame section of the same folding wing in which also the locking pin is located, the two pins can be connected parallel but fixedly to each other with regard to their movement so that the reinforcement pin is arranged to be moved together with the locking pin. A coupling extending through the movable intermediate space between two folding wings is therefore not required. The locking action of both pins can still be realized by means of only one locking gear. Due to the additional reinforcement pin, the locking forces act however at several locations (locking pin and reinforcement pin); the load or force on the individual pins is thus at least cut in half. In case of burglary attempts or in case of wind loads acting on the folding system, the force introduction into the guide rail is distributed in an improved way and reduces the risk of bending of the guide rail or of the pins. When neighboring folding wings are connected by hinges, the improved locking action extends also to the folding wing that is neighboring the locking action. The locking action according to the invention can however be used also in relation to a wall or used in case of folding wings which are not fixedly connected to a neighboring wing, in particular not connected by hinges.

In addition to securing against burglary, a reliable closing action of folding systems at high wind loads is advantageous in particular. In this context, it is particularly positive when the reinforcement pin is accommodated in a supplemental reinforcement section of the frame section so that the stability of the folding wing against bending is increased. With an appropriate configuration, bending of the folding wing at wind load can be reduced so much that there is no risk anymore that locking pin and reinforcement pin can jump out of the guide rails. Also, a supplemental reinforcement section, in particular when it is detachably connected to the existing frame section piece, can be retrofitted without problem or can be provided only when needed. However, it is also possible to configure the reinforcement section as one piece together with the section piece that accommodates the locking pin.

An improvement of the stability can also be achieved when the frame section comprises a blade-shaped projection that extends vertically and counteracts bending. The projection has preferably a strip-shaped or blade-shaped configuration with a height that preferably occupies most of the height of the vertical frame section. Compared thereto, the width of the projection is rather minimal, and its depth, i.e., its extension measured perpendicular to the plane of the folding wing, is preferably larger than its width. The projection can be embodied as one piece together with the frame section or can be connected to it. When this projection is arranged at the reinforcement section, the number of required components for various embodiments can however be kept small because the required stability can be adjusted, as needed, by selecting a suitable reinforcement section, with or without projection.

In a constructively simple way, without having to modify the configuration of the locking gear, the reinforcement pin can be connected by means of an adapter piece to the locking pin. In case of retrofitting, it can be advantageous when the adapter piece for this purpose has a mounting cutout which enables access by a tool for producing the connection. The adapter piece can be designed substantially in a C shape or U shape for this purpose.

Moreover, the adapter piece can be utilized constructively for guiding the movement of the reinforcement pin. In this context, it is advantageous when the adapter piece comprises a guide surface which is contacting a mating guide surface of the reinforcement section. A corresponding configuration is possible also opposite thereto in the section piece.

The C-shaped or U-shaped adapter piece comprises preferably at least two substantially horizontal legs which are connected by means of at least one substantially vertical leg. In the substantially horizontal legs, coupling regions are formed at which force transmitting elements, in particular locking rods, engage for force transmission to the pins. Between the substantially horizontally extending legs, there is a mounting cutout whose unobstructed height in vertical direction is preferably larger than the height measured in vertical direction of the substantially horizontal legs, in particular even the sum of the height of the substantially horizontal legs. This configuration facilitates mounting and servicing of the folding system. In a concrete case, the unobstructed height of the mounting cutout should correspond at least to the length of connecting elements to be employed, for example, screws including the screw heads, which pass through the coupling regions.

The coupling regions of the adapter piece are at least partially embodied as recesses or partially even as through bores and can extend from the bottom or the top preferably parallel through the adapter piece. At least one of the two recesses is in particular configured as a through bore through a first leg of the substantially horizontal legs. The other recess in this leg can be a blind bore. In the mounted state of the folding system, each of the two recesses can receive a locking rod. One of the locking rods in this context is connected to the locking pin while the other one of the locking rods is connected to the reinforcement pin. A third recess is preferably provided as a through bore through a second one of substantially horizontal legs. In the mounted state of the folding system, this bore can receive of push rod for introducing a force. Particularly preferred, one such adapter piece, as described, is arranged at the locking gear at both sides.

The transmission of the locking forces to the guide rails is realized particularly reliably, but gently in regard to the material, when the locking pin and the reinforcement pin are spaced apart from each other with regard to their contact points at the guide rails. The spacing can correspond approximately to the diameter of the pins. It is advantageous when the spacing is at least as large as the supporting penetration depth of the pins in the guide rail.

Further advantages and details result from the dependent claims and the embodiments of the invention illustrated in the drawing which will be described in the following.

### BRIEF DESCRIPTION OF THE DRAWING

FIG. 1 shows the connecting region of two folding wings in a locked position in a front view.

FIG. 2 shows the connecting region according to FIG. 1 in a perspective view and in an exploded view with components that are partially spaced apart from each other.

FIG. 3 shows the connecting region of FIG. 1 illustrating the locking components.

FIG. 4 shows the connecting region of FIG. 3 in unlocked position.

FIG. 5 is a section view along section line V-V through the connecting region of FIG. 1; FIG. 5a shows a variant with a blade-shaped projection.

FIG. 6 shows an alternative embodiment in an illustration corresponding to that of FIG. 5; FIG. 6a shows a variant with a blade-shaped projection.

### DESCRIPTION OF THE PREFERRED EMBODIMENTS

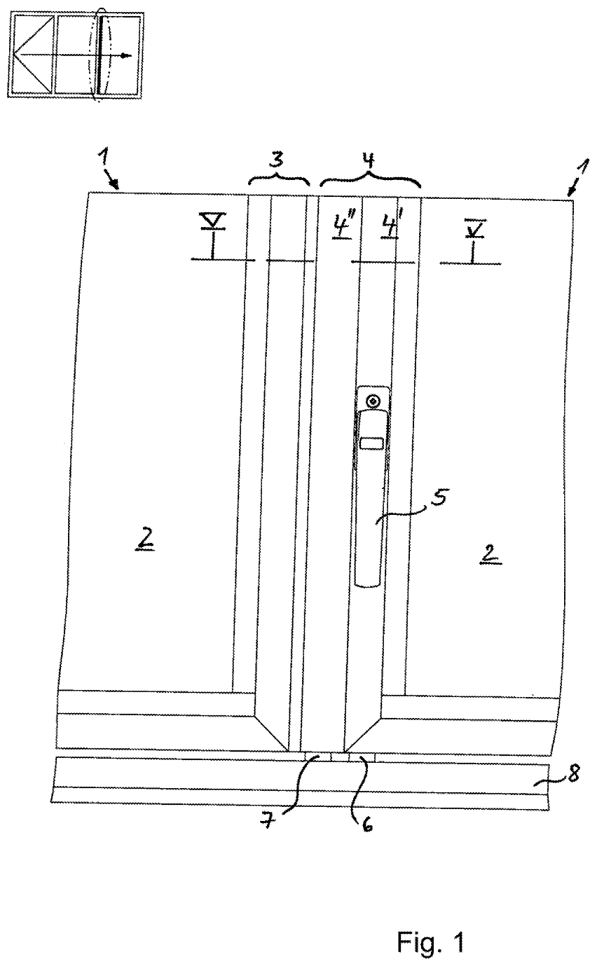

FIG. 1 shows the bottom region of two folding wings 1 connected to each other in the closed functional position of the locking action. At the top to the left there is a small pictograph illustration of an exemplary folding system for illustrating the function. The illustrated folding wings 1 are guided in a guide comprising a top guide rail and a bottom guide rail 8. The illustrated folding wings 1 each have glass panes 2 which are secured in frame sections 3, 4. The folding wing 1 to the right in the illustration comprises a locking action that can be actuated by means of a grip 5. By means of the grip 5, a locking pin 6 and a reinforcement pin 7 can be moved into the bottom guide rail 8 so that pivoting of the folding wings can be prevented. The locking pin 6 is guided in a section piece 4′ of the frame section 4 while the reinforcement pin 7 is accommodated in a reinforcement section 4″ of the frame section 4.

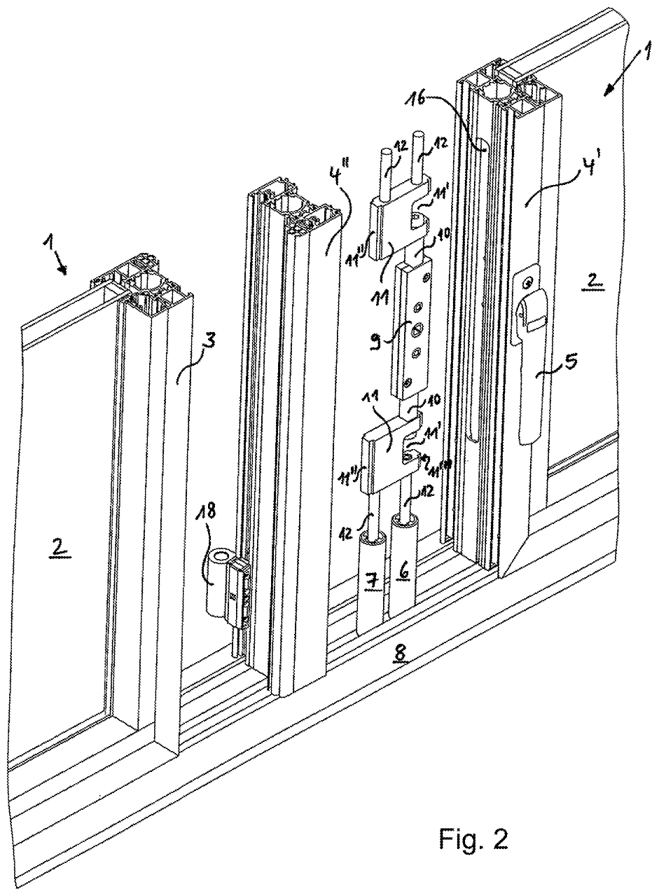

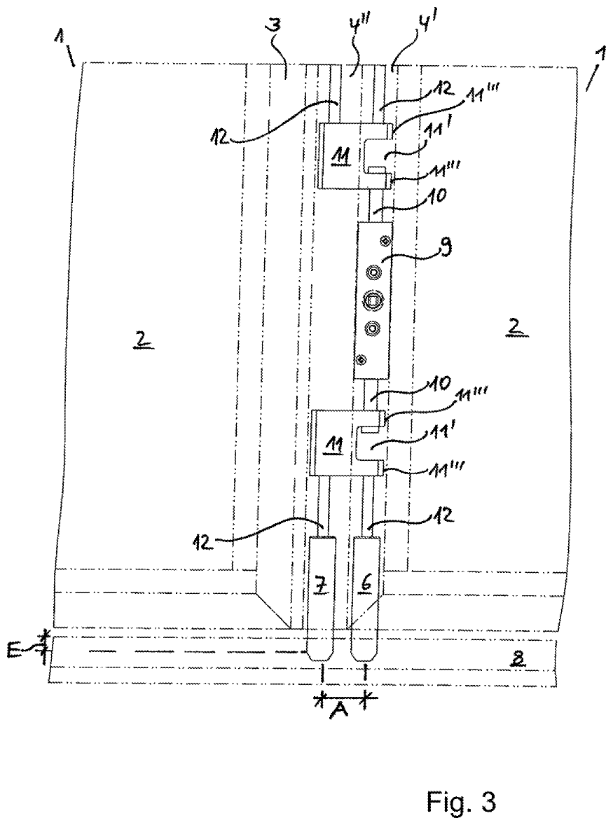

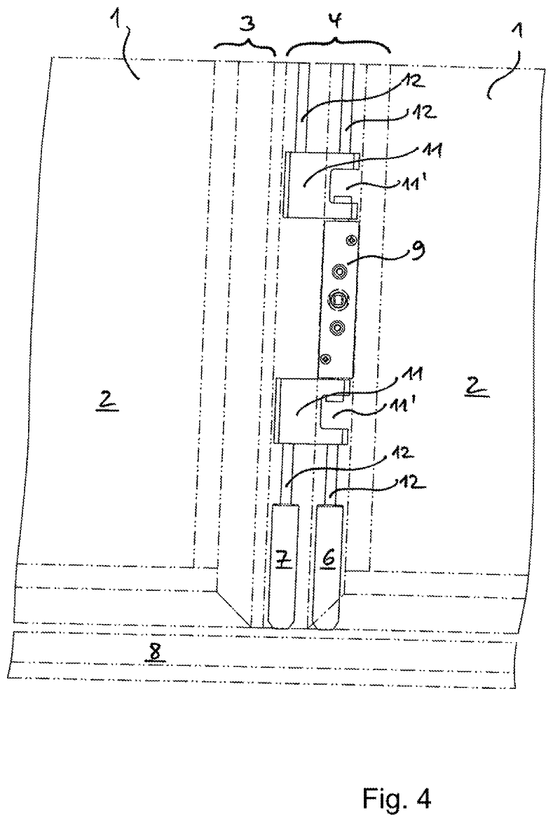

FIGS. 2 through 5 illustrate the function and the individual components of the construction according to the invention. In FIGS. 3 and 4, the grip 5 is eliminated, and the frame sections 3, 4 and the bottom guide rail 8 are illustrated transparent in dash-dotted line so that the internally positioned locking gear 9 and components connected thereto are visible. The locking gear 9 is acting by push rods 10 and adapter pieces 11 adjoining them on locking rods 12 that are connected to the adapter pieces 11. The locking rods 12 have at their ends a locking pin 6 and a reinforcement pin 7, respectively. The upper locking rods 12 also carry such a locking pin 6 and such a reinforcement pin 7 in this embodiment; however, these pins and the top guide rail that they engage cannot be seen in this illustration due to the cut-off top part. Of course, the ends of the locking rods 12 can also themselves form the locking pin 6 and the reinforcement pin 7 and/or can also transition into them in a one-piece configuration.

In FIGS. 2 and 3, the locking action is shown in its closed functional position wherein the locking pin 6 and the reinforcement pin 7 are immersed in the bottom guide rail 8 and lock the folding wings 1 in this way. FIG. 4, on the other hand, shows the locking action in its open position. For opening the folding system, the grip 5, not illustrated here, has been rotated by 180° in upward direction and, in this way, by means of the locking gear 9, the adapter pieces 11 with the connected locking rods 12 and the locking pin 6 and the reinforcement pin 7 have been displaced toward the locking gear 9. The locking pin 6 and the reinforcement pin 7 are located now outside of the guide rail 8 and release the folding wings 1 so that they can be opened. In order to distribute the locking forces in the guide rail 8, the locking pin 6 and the reinforcement pin 7 are positioned spaced apart at a distance A from each other (see FIG. 3). The distance A is measured in the illustrated embodiment between the central longitudinal axes of the locking pin 6 and of the reinforcement pin 7 because the locking pin 6 and the reinforcement pin 7 are round and therefore contact the guide rail 8 only with a line contact. The distance A should correspond at least to the supporting penetration depth E (see FIG. 3) of the locking pin 6 and the reinforcement pin 7 in the guide rail 8, preferably however be larger, particularly preferred even twice as large.

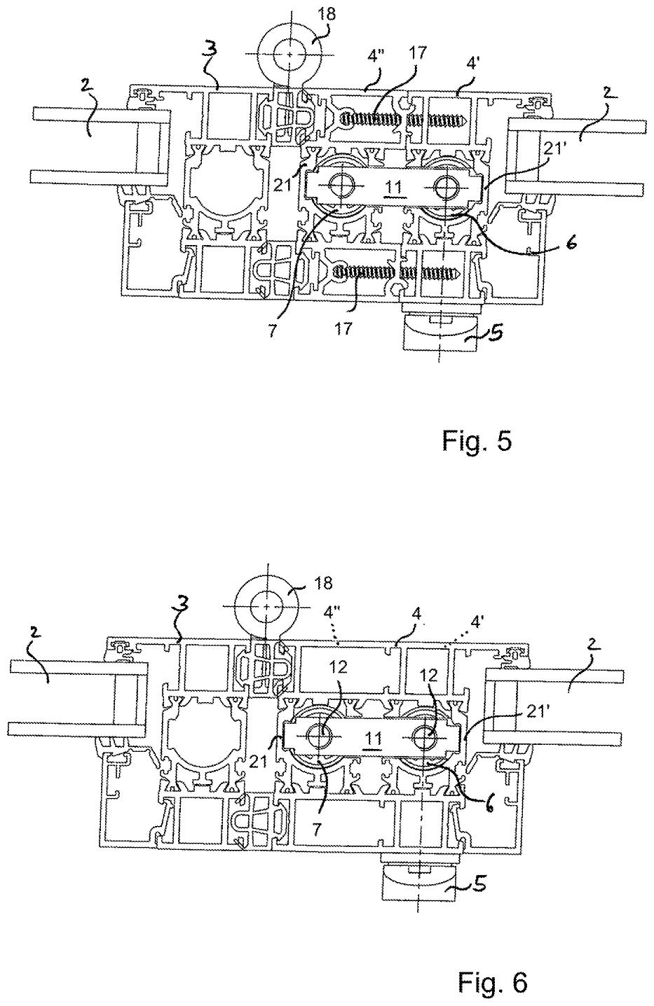

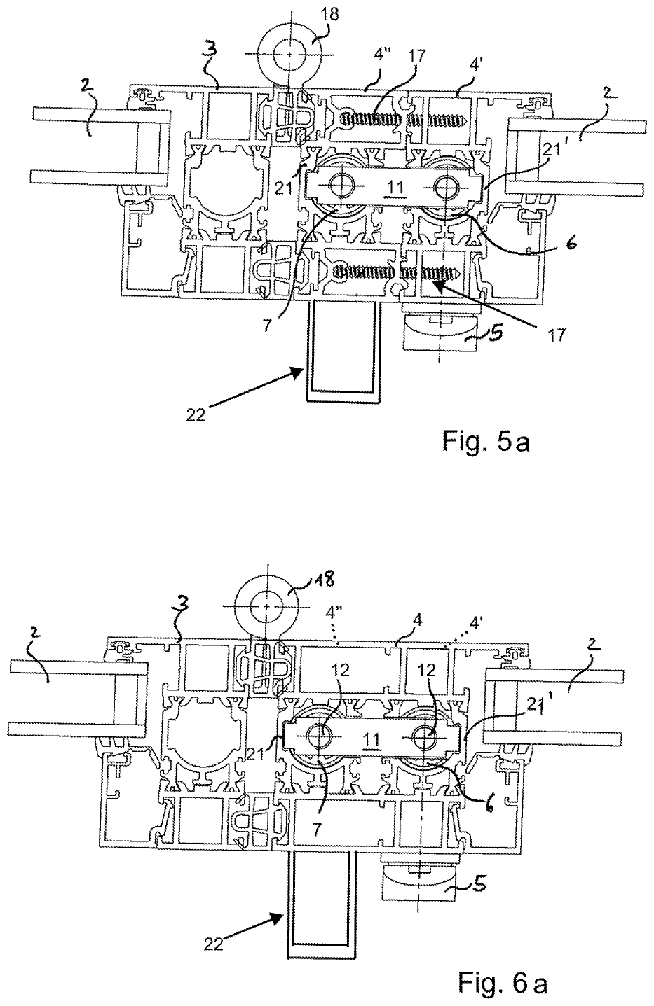

Further details of the construction can be taken from FIGS. 2 and 5 as well as the variant illustrated in FIG. 6. In the assembled state, the locking gear 9 is arranged with the push rods 10 in the section piece 4′ of the frame section 4. The reinforcement pin 7 with the corresponding part of the adapter piece 11, on the other hand, is located in the reinforcement section 4″. At the transition from the section piece 4′ to the reinforcement section 4″, both parts 4′, 4″ have a cutout 16 (see FIG. 2) through which the adapter pieces 11 extend. The cutouts 16 are to be designed so large that they enable the upward and downward movement of the adapter pieces 11 during locking and unlocking. The adapter pieces 11 have mounting cutouts 11′ that permit attachment of the adjoining push rods 10 and locking rods 12 at the adapter pieces 11 by means of a corresponding tool. At the side facing the reinforcement section 4″, the adapter pieces 11 have guide surfaces 11″ that are contacting a mating guide surface 21 of the reinforcement section 4″ so that the upward and downward movement of the adapter pieces 11 is stabilized and guided. In the illustrated embodiment, corresponding guide surfaces 11′″ for improving stability are advantageously also provided at the opposite side and are contacting a mating guide surface 21′ of the section piece 4′.

While FIGS. 1 through 5 show an embodiment in which the frame section 4 is comprised of two section parts, i.e., the section piece 4′ and the reinforcement section 4″ which are detachably connected to each other by means of screw connections 17, FIG. 6 shows an alternative embodiment with a one-piece configuration of the frame section 4. In both cases, however, the frame section 4 is connected by hinge fittings 18 to the frame section 3 of the neighboring folding wing 1 so that the two folding wings 1 in the final mounted state of the folding system and in an open position of the locking action are pivotable relative to each other but remain connected to each other.

An improvement of the stability can also be achieved when the frame section 4 comprises a blade-shaped projection 22, schematically illustrated in FIGS. 5a and 6a, respectively, that extends vertically and counteracts bending. The projection 22, a reinforcement chamber, has preferably a strip-shaped or blade-shaped configuration with a height that preferably occupies most of the height of the vertical frame section 4. Compared thereto, the width of the projection 22 is rather minimal, and its depth, i.e., its extension measured perpendicular to the plane of the folding wing, is preferably larger than its width. The projection 22 can be embodied as one piece together with the frame section 4, as illustrated, or can be connected to it. When this projection 22 is arranged at the reinforcement section 4, the number of required components for various embodiments can however be kept small because the required stability can be adjusted, as needed, by selecting a suitable reinforcement section, with or without projection.

The constructive configuration of the folding system according to the invention and in particular of its locking action is simple, robust, low maintenance, and secure.

The specification incorporates by reference the entire disclosure of German priority document 10 2019 125 988.6 having a filing date of Sep. 26, 2019.

While specific embodiments of the invention have been shown and described in detail to illustrate the inventive principles, it will be understood that the invention may be embodied otherwise without departing from such principles.

What is claimed is:

1. A folding system comprising:
a bottom guide rail and a top guide rail;
a first folding wing supported movably in the bottom guide rail and the top guide rail;
a second folding wing supported movably in the bottom guide rail and the top guide rail;
the first folding wing comprising a vertically extending frame section;
a lock fitting arranged in the vertically extending frame section of the first folding wing and comprising a vertically slidably supported locking pin;
a locking gear operatively connected to the vertically slidably supported locking pin and configured to move the vertically slidably supported locking pin into and out of one of the bottom and top guide rails;
a reinforcement pin disposed in the vertically extending frame section of the first folding wing and arranged parallel to the vertically slidably supported locking pin;
the vertically slidably supported locking pin and the reinforcement pin connected to each other such that the reinforcement pin is entrained to move parallel to the vertically slidably supported locking pin when the locking gear is actuated.

2. The folding system according to claim 1, wherein the vertically extending frame section of the first folding wing comprises a reinforcement section that accommodates the reinforcement pin.

3. The folding system according to claim 2, wherein the vertically extending frame section of the first folding wing comprises a section piece accommodating the vertically slidably supported locking pin, wherein the reinforcement section is detachably connected to the section piece.

4. The folding system according to claim 2, wherein the vertically extending frame section of the first folding wing comprises a section piece accommodating the vertically slidably supported locking pin, wherein the reinforcement section and the section piece are configured together as one piece.

5. The folding system according to claim 2, further comprising an adapter piece, wherein the adapter piece connects the vertically slidably supported locking pin and the reinforcement pin to each other.

6. The folding system according to claim 5, wherein the adapter piece comprises at least one mounting cutout.

7. The folding system according to claim 5, wherein the adapter piece comprises at least one guide surface configured to contact a mating guide surface of the reinforcement section.

8. The folding system according to claim 1, wherein the vertically slidably supported locking pin and the reinforcement pin are spaced apart from each other.

9. The folding system according to claim 1, wherein the vertically extending frame section of the first folding wing comprises at least one vertically extending blade-shaped projection.

10. The folding system according to claim 9, wherein the vertically extending frame section of the first folding wing comprises a reinforcement section that accommodates the reinforcement pin, wherein the reinforcement section comprises the blade-shaped projection.
